(19) United States
(12) Patent Application Publication
(10) Pub. No.: US 2006/0018450 A1
(43) Pub. Date: Jan. 26, 2006

(54) Mobile telephone transaction system employing electronic account card

(76) Inventor: Erik Sandberg-Diment, Hampton, CT (US)

Correspondence Address: DELIO & PETERSON, 121 WHITNEY AVENUE, NEW HAVEN, CT, 06510, US

(21) Appl. No.: 10/899,507

(22) Filed: Jul. 26, 2004

(51) Int. Cl. H04M 11/00

(52) U.S. Cl. 379/93.12; 379/93.03

(57) ABSTRACT

A method of conducting a transaction at a point-of-sale with a consumer. The consumer uses mobile telephone with a memory library capable of storing a plurality of account numbers, a menu to select a desired account number from the library, and capability to transmit an account number to a point-of-sale (POS) device via wired or wireless communication. The method includes receiving a plurality of account numbers from different vendors, and storing the account numbers in the mobile telephone's library. The method also includes providing a POS device, used by a merchant, having capability to receive an account number from a consumer's mobile telephone via wired or wireless communication to conduct a transaction with the consumer. The method then comprises approaching the POS device with the mobile telephone within a range of ten meters, selecting from the library menu of the mobile telephone the desired account number for the POS device, transmitting the selected account number from the mobile telephone to the POS device, and at the POS device, approving a transaction with the consumer based on the selected account number.

### BACKGROUND OF THE INVENTION

1. Field of the Invention

The present invention relates to a method of conducting a transaction at a point-of-sale with a consumer and, in particular, to a method employing a mobile telephone with an electronic account card.

2. Description of Related Art

The average consumer carries numerous account numbers and other identification such as those for credit cards, affinity cards for stores, program cards such as those for health insurance, and others. While the vendors of such account numbers attempt to simplify matters by placing them on wallet or key chain cards that may be read magnetically or optically, eventually the quantity of such cards makes storage inconvenient.

While electronically communicated account numbers are now entering some areas, such as the EZPass highway toll collection system or the Speedpass gasoline charge system, such systems are limited to a single account number. Moreover, except for distance from the point-of-sale (POS) device with which these portable devices communicate, the consumer has no control over whether to proceed with the electronic transaction.

### SUMMARY OF THE INVENTION

Bearing in mind the problems and deficiencies of the prior art, it is therefore an object of the present invention to provide an improved method and system for electronically conducting a transaction at a point-of-sale with a consumer.

It is another object of the present invention to provide an electronic account number communication system which is under the complete control of the consumer.

A further object of the invention is to provide an improved mobile telephone that facilitates the control and communication of consumer account numbers to a point-of-sale device.

It is yet another object of the present invention to provide a method and system of receiving and storing account numbers from a vendor for use in a transaction involving the vendor's product or services.

Still other objects and advantages of the invention will in part be obvious and will in part be apparent from the specification.

The above and other objects, which will be apparent to those skilled in art, are achieved in the present invention which is directed to a method of conducting a transaction at a point-of-sale with a consumer in which there is provided a mobile telephone or other portable electronic device used by a consumer. The mobile telephone or other device has a memory library capable of storing a plurality of account numbers, a menu to select a desired account number from the library, and capability to transmit an account number to a POS device via wired or wireless communication. The method includes receiving a plurality of account numbers from different vendors, and storing the account numbers in the library of the mobile telephone or other device. The method also includes providing a point-of-sale (POS) device used by a merchant, with the POS device having capability to receive an account number from a consumer's mobile telephone via wired or wireless communication to conduct a transaction with the consumer. The method then comprises approaching the POS device with the mobile telephone within a range of ten meters, preferably within two meters or less, selecting from the library menu of the mobile telephone or other device the desired account number for the POS device, transmitting the selected account number from the mobile telephone or other device to the POS device, and at the POS device, approving a transaction with the consumer based on the selected account number received from the consumer's mobile telephone or other device.

The account number may be, for example, a credit card number to enable the consumer to charge the cost of the transaction to a credit card company, or a discount number to enable the consumer to receive a discount from the cost of the transaction from a vendor.

Preferably, the method further includes transmitting a security code from the mobile telephone or other device to the POS device to verify that the consumer is authorized to use the mobile telephone or other device. The approval of the transaction at the POS device is then based on the security code received from the consumer's mobile telephone or other device. More preferably, the security code is inputted to the mobile telephone or other device prior to transmitting the security code to the POS device. The security code transmitted from the mobile telephone or other device to the POS device may be an identifying indicia of the authorized consumer, such as a photograph, fingerprint, ear image or iris image.

### BRIEF DESCRIPTION OF THE DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 is a schematic showing a typical transaction and verification with a POS device in accordance with the present invention.

FIG. 2 is a block diagram showing the preferred method of the present invention.

FIG. 3 is an elevational view of a mobile telephone useful with the present invention.

### DESCRIPTION OF THE PREFERRED EMBODIMENT(S)

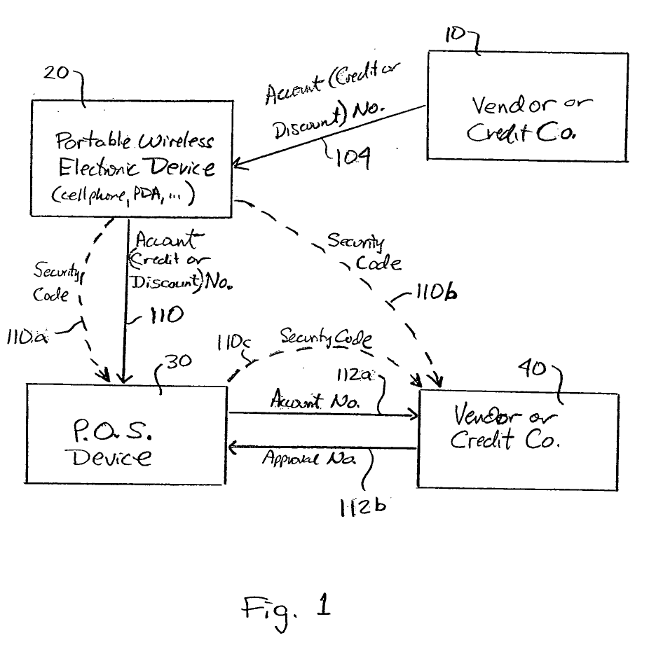

In describing the preferred embodiment of the present invention, reference will be made herein to FIGS. 1-3 of the drawings in which like numerals refer to like features of the invention.

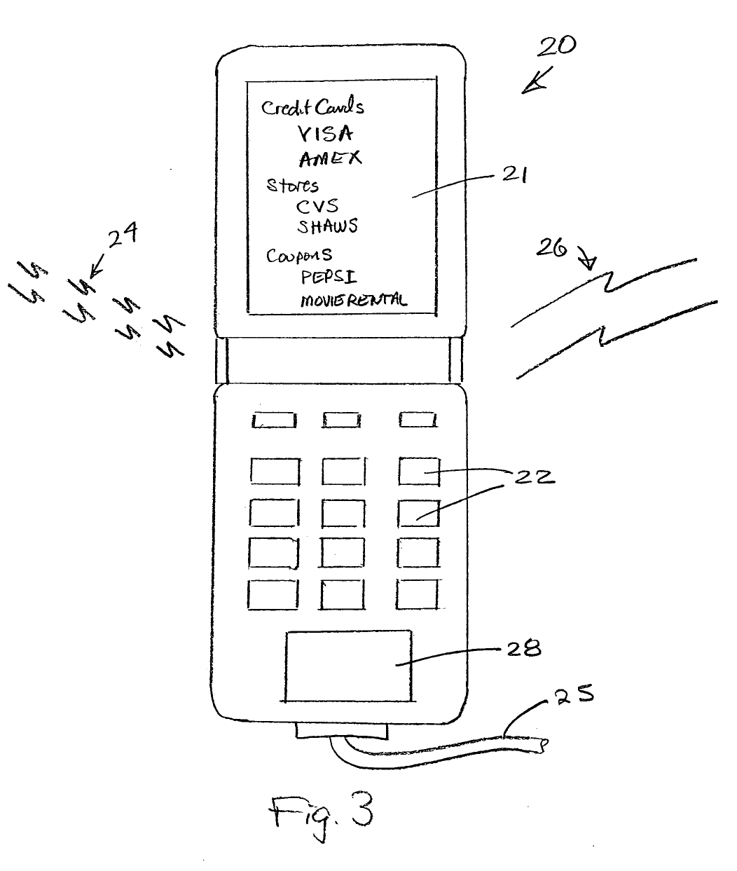

As used herein, the term portable electronic device refers to a hand-held electronic device that is capable of electronically storing account numbers, and communicating the account numbers to other devices within a short range, such as ten meters, typically two meters or less, either with a wired connection such as a USB or Firewire connection, or over a wireless network such as WiFi, Bluetooth, GSM, CDMA, TDMA, and the like. Examples of such portable electronic devices include mobile wireless (e.g., cellular) telephones, personal digital assistants (PDAs), notebook or tablet computers, portable game players, and the like. While the method of the present invention is useful in connection with any such portable electronic device, preferably the device is a mobile (i.e., wireless or cellular) telephone 20, as shown in FIG. 3, and the examples given herein will be with respect to such mobile telephone. Such mobile telephone will include a memory (not shown) capable of storing a library of numbers, in this case account numbers provided by vendors with which the consumer does, or desires to do, business. The mobile telephone will also have a display 21 that permits a menu of the stored account numbers to be viewed and selected by the consumer. Upon selection, the mobile telephone will transmit the desired account number electronically to the POS device.

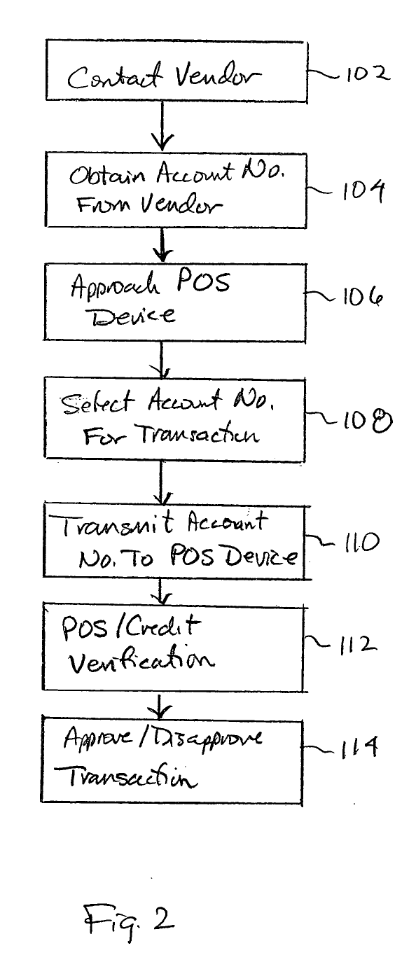

The preferred transaction method and system of the present invention is depicted in schematic form in FIG. 1, while the preferred steps of the method are shown in FIG. 2. Initially, a vendor 10 is contacted by a customer (102, FIG. 2) to obtain an account number 104 that the customer desires to use in a transaction at a point-of-sale. This account number may be a credit card number which the consumer will obtain from a credit card company. Alternatively, or in addition to such credit information, the consumer may obtain from a vendor of goods or services a discount number, which may be an electronic version of a conventional discount coupon of the type normally provided in print media such as in magazines, newspapers or direct mail. This discount number may be displayed in a television advertisement, in an Internet website or even via traditional print media. This discount number may be used separately or may be linked to a credit card number so that the discount transaction occurs automatically when making the purchase with the credit number.

In one embodiment the consumer may enter the account number manually into a memory of the mobile telephone 20. Alternatively, the mobile telephone 20 may be connected via USB, Firewire or other wired communication protocol 25 (FIG. 3) to a computer logged on to vendor's website. The consumer may repeatedly store a plurality of different account numbers for various credit cards, vendor discounts, vendor affinity numbers, health or automobile insurance account numbers and the like. These stored account numbers may be in the memory library of the mobile telephone 20 and displayed on a menu on the telephone screen 21.

Once the consumer and the mobile telephone 20 approaches a point-of-sale device 30 (106, FIG. 2), the consumer selects from the menu screen 21 the desired account number to be transmitted (108, FIG. 2). The consumer is typically within a range of one to two meters of the POS device when the transaction is to be conducted. The consumer mobile telephone may then contact the POS device electronically either with a wired connection or wirelessly and transmit the account number 110. With a wired connection, the POS device may provide, for example, a USB or Firewire connector 25 (FIG. 3) to which the mobile telephone corresponding socket may be connected. For a wireless connection, the mobile telephone may utilize a relatively short range wireless network communication system 24 such as WiFi or Bluetooth. The mobile telephone may also be equipped with a radio frequency identification (RFID) system that transmits selected account numbers when interrogated or read by the POS. Alternatively, the mobile telephone may call a particular telephone number associated with the POS device and therefore communicate wirelessly over its own conventional voice/data networks such as a CDMA, TDMA, GSM or other longer range wireless or cellular network 26.

Once the POS device receives the account number from the mobile telephone, it processes the account number in accordance with the transaction requested (112, FIG. 2). In the case of a discount number, it would check the discount number against a data base, which may be provided by the vendor that originated the discount number to ensure that the transaction is made in accordance with the rules associated with that discount. In the case of a credit-card number, the POS device will typically request an authorization from the credit card company that issued the credit card to approve the use of the card for that particular transaction (112a, FIG. 1). Alternatively, the consumer may utilize a credit verification method of the type described in U.S. Pat. No. 5,826,245 by the inventor of this application, the disclosure of which is hereby incorporated by reference. In such case, the mobile telephone will send a portion of the account number to the POS device (110a, FIG. 1) and a portion directly to the credit card company (110b, FIG. 1), for example, by automatically dialing a telephone number for the credit card company. The POS device will in turn transmit its portion of the credit number to the credit card company (110c, FIG. 1). Once the credit card company verifies that the account number and transaction are authorized, it sends verification information to the POS device (112b, FIG. 1), which then approves or disapproves the transaction (114, FIG. 2).

Other security methods may be employed to ensure that the consumer utilizing the mobile telephone for the transaction is authorized to do so. Such security methods may include the consumer manually punching into the telephone keyboard 22 (FIG. 3) a PIN corresponding to a security code recognized by the vendor or credit card company, and transmitting the PIN to the POS device (110a, FIG. 1). Alternatively, the telephone may hold in memory and display for the person operating the POS device a photograph of the consumer who is authorized to use the mobile telephone. Also, the mobile telephone may incorporate more sophisticated identification verification means such as a scanner 28 (FIG. 3) that would record and hold in memory other identifying indicia, such as a fingerprint or ear or iris image of the authorized consumer, which would then be verified by scanning and matching at the time of the transaction at the POS device.

Typically, the POS device will be a cash register at a store offering goods or services to be provided by the consumer's transaction. The POS device may be associated with public transport systems, such as highway toll collection systems, or bus or subway fare collection systems. The POS device may also be a non-monetary device such as a security gate or a lock on a door, which the mobile telephone may contact with authorization in the form of the account number to unlock. Another POS device may be an instructional post at a tourist location, for example, a museum or park. Contact between the mobile telephone and POS device would include the aforementioned transfer of an account number, and may be followed by downloading or real time broadcasting of voice or data information about the site being visited.

Accordingly, the present invention provides a secure means of employing a mobile telephone to electronically conduct a transaction at a point-of-sale with a consumer by replacing any one of a number of normal account identification cards. It permits receiving and storing account numbers from vendors for use in transactions involving the vendors' products or services, such as discount numbers that the vendor may transmit over non-print media. The system also has the advantage that the electronic account number communication is under the complete control of the consumer.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

Thus, having described the invention, what is claimed is:

1. A method of conducting a transaction at a point-of-sale with a consumer comprising:
providing a mobile telephone used by a consumer, the mobile telephone having a memory library capable of storing a plurality of account numbers, a menu to select a desired account number from the library, and capability to transmit an account number to a POS device via wired or wireless communication;
receiving a plurality of account numbers from different vendors, and storing the account numbers in the library of the mobile telephone;
providing a point-of-sale (POS) device used by a merchant, the POS device having capability to receive an account number from a consumer's mobile telephone via wired or wireless communication to conduct a transaction with the consumer;
approaching the POS device with the mobile telephone within a range of ten meters; at the mobile telephone, selecting from the library menu the desired account number for the POS device;
transmitting the selected account number from the mobile telephone to the POS device;
at the POS device, approving a transaction with the consumer based on the selected account number received from the consumer's mobile telephone.

2. The method of claim 1 wherein the account number is a credit card number to enable the consumer to charge the cost of the transaction to a credit card company.

3. The method of claim 1 wherein the account number is a discount number to enable the consumer to receive a discount from the cost of the transaction from a vendor.

4. The method of claim 1 further including transmitting a security code from the mobile telephone to the POS device to verify that the consumer is authorized to use the mobile telephone, and wherein the approval of the transaction at the POS device is based on the security code received from the consumer's mobile telephone.

5. The method of claim 4 further including inputting a security code to the mobile telephone prior to transmitting the security code to the POS device.

6. The method of claim 4 wherein the security code transmitted from the mobile telephone to the POS device is an identifying indicia of the authorized consumer.

7. The method of claim 5 wherein the security code transmitted from the mobile telephone to the POS device is selected from the group consisting of a photograph, fingerprint, ear image and iris image.

8. The method of claim 1 wherein the POS device has capability to receive an account number from a consumer's mobile telephone via wired communication, and wherein the selected account number is transmitted via wired communication from the mobile telephone to the POS device.

9. The method of claim 1 wherein the POS device has capability to receive an account number from a consumer's mobile telephone via wireless communication, and wherein the selected account number is transmitted via wireless communication from the mobile telephone to the POS device.

10. The method of claim 1 wherein the POS device is approached with the mobile telephone within a range of two meters.

11. A method of conducting a transaction at a point-of-sale with a consumer comprising:
providing a mobile telephone used by a consumer, the mobile telephone having a memory library capable of storing a plurality of account numbers, a menu to select a desired account number from the library, and capability to transmit an account number to a POS device via wired or wireless communication;
receiving a plurality of account numbers from different vendors, and storing the account numbers in the library of the mobile telephone;
providing a point-of-sale (POS) device used by a merchant, the POS device having capability to receive an account number from a consumer's mobile telephone via wired communication to conduct a transaction with the consumer;
approaching the POS device with the mobile telephone within a range of two meters;
at the mobile telephone, selecting from the library menu the desired account number for the POS device;
transmitting the selected account number from the mobile telephone to the POS device via wireless communication;
at the POS device, approving a transaction with the consumer based on the selected account number received from the consumer's mobile telephone.

12. The method of claim 11 wherein the account number is a credit card number to enable the consumer to charge the cost of the transaction to a credit card company.

13. The method of claim 11 wherein the account number is a discount number to enable the consumer to receive a discount from the cost of the transaction from a vendor.

14. The method of claim 1 further including transmitting a security code from the mobile telephone to the POS device to verify that the consumer is authorized to use the mobile telephone, and wherein the approval of the transaction at the POS device is based on the security code received from the consumer's mobile telephone.

15. The method of claim 14 further including inputting a security code to the mobile telephone prior to transmitting the security code to the POS device.

16. A method of conducting a transaction at a point-of-sale with a consumer comprising:
providing a mobile telephone used by a consumer, the mobile telephone having a memory library capable of storing a plurality of account numbers, a menu to select a desired account number from the library, and capability to transmit an account number to a POS device via wired or wireless communication;
receiving a plurality of account numbers from different vendors, and storing the account numbers in the library of the mobile telephone;
providing a point-of-sale (POS) device used by a merchant, the POS device having capability to receive an account number from a consumer's mobile telephone via wired communication to conduct a transaction with the consumer;
approaching the POS device with the mobile telephone within a range of two meters;
at the mobile telephone, selecting from the library menu the desired account number for the POS device;
transmitting the selected account number from the mobile telephone to the POS device via wired communication;
at the POS device, approving a transaction with the consumer based on the selected account number received from the consumer's mobile telephone.

17. The method of claim 16 wherein the account number is a credit card number to enable the consumer to charge the cost of the transaction to a credit card company.

18. The method of claim 16 wherein the account number is a discount number to enable the consumer to receive a discount from the cost of the transaction from a vendor.

19. The method of claim 1 further including transmitting a security code from the mobile telephone to the POS device to verify that the consumer is authorized to use the mobile telephone, and wherein the approval of the transaction at the POS device is based on the security code received from the consumer's mobile telephone.

20. The method of claim 19 further including inputting a security code to the mobile telephone prior to transmitting the security code to the POS device.
